(19) United States
(12) Patent Application Publication
(10) Pub. No.: US 2015/0333396 A1
(43) Pub. Date: Nov. 19, 2015

(54) MULTI-BAND ANTENNA

(71) Applicant: FOXCONN INTERCONNECT TECHNOLOGY LIMITED, Grand Cayman (KY)

(72) Inventors: LUNG-SHENG TAI, New Taipei (TW); TZU-YAO HWANG, New Taipei (TW)

(21) Appl. No.: 14/709,482

(22) Filed: May 12, 2015

(30) Foreign Application Priority Data
May 14, 2014 (TW) 103208360

(51) Int. Cl. H01Q 1/50; H01Q 1/48

(52) U.S. Cl. CPC H01Q 1/50; H01Q 1/48

(57) ABSTRACT

A multi-band antenna includes a feeder cable including an inner wire and an outer braider, and an antenna body. The antenna includes a longitudinal grounding portion along a first direction, a first connecting portion and a second connecting portion extending from opposite first and second ends of the grounding portion, a first arm extending from the first connecting portion and a second arm extending from the second connecting portion along the first direction. The second connecting portion defines a signal joint point at a corner near to the first arm and the grounding portion, the inner wire of the feeder cable is soldered to the joint point and the outer braider of the feeder cable is soldered to the grounding portion. The first arm and the second arm are partly overlapped in a second direction perpendicular to the first direction.

### BACKGROUND OF THE INVENTION

1. Field of the Invention

The present invention relates generally to a multi-band antenna, and more particularly to a multi-band antenna used in an electronic device.

2. Description of the Related Art

PIFA (Planar Inverted-F Antenna) is usually used in an electronic device. U.S. Pat. No. 7,136,025 discloses a multi-band antenna defining a radiating element operating at two different frequency bands, a connecting element and a grounding element. A slot is formed between the radiating element and the grounding element for adjusting an impedance of the antenna. Thus, it is difficult to reduce a distance between the radiating element and the grounding element. If the distance is decreased, as a result, the radiation effect of the antenna will be influenced. Nowadays, electronic device becomes more and more small. Therefore, the traditional PIFA can not fully meet the requirement of the miniaturization of the electronic device.

Hence, in this art, a multi-band antenna to overcome the above-mentioned disadvantages of the prior art will be described in detail in the following embodiment.

### BRIEF SUMMARY OF THE INVENTION

A primary object, therefore, of the present invention is to provide a multi-band antenna occupying small space.

In order to implement the above object and overcome the above-identified deficiencies in the prior art, a multi-band antenna comprises a feeder cable comprising an inner wire and an outer braider and an antenna body. The antenna comprises a longitudinal grounding portion along a first direction, a first connecting portion and a second connecting portion extending from opposite first and second ends of the grounding portion, a first arm extending from the first connecting portion and a second arm extending from the second connecting portion along the first direction. The second connecting portion defines a joint point at a corner near to the first arm and the grounding portion, the inner wire of the feeder cable is soldered to the joint point and the outer braider of the feeder cable is soldered to the grounding portion. The first arm and the second arm are partly overlapped in a second direction perpendicular to the first direction.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is an exploded perspective view of a multi-band antenna according to this present invention;

FIG. 2 is an assembled perspective view of the multi-band antenna FIG. 1;

FIG. 3 is a test chart recording of Voltage Standing Wave Ratio (VSWR) of the multi-band antenna as a function of frequency;

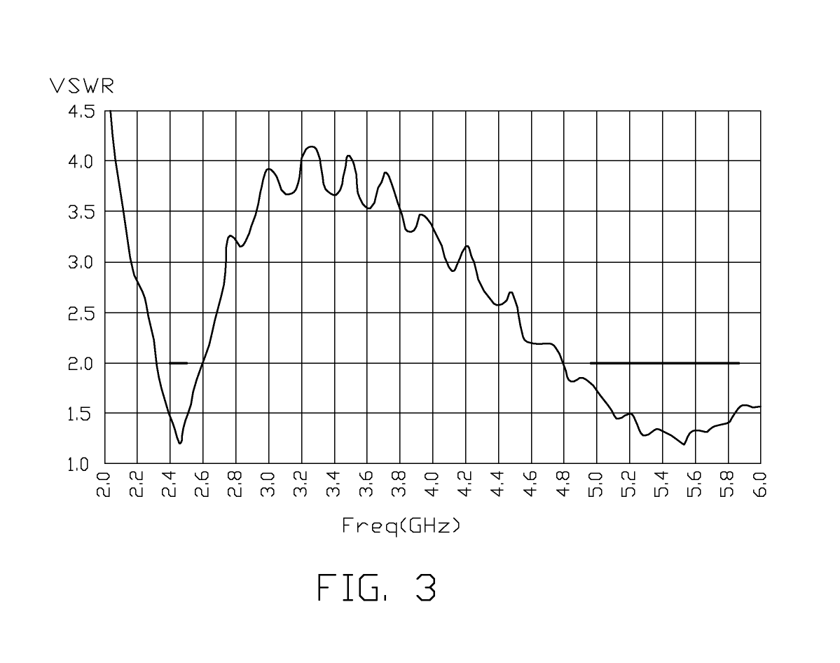

### DETAILED DESCRIPTION OF THE INVENTION

Reference will now be made in detail to a preferred embodiment of the present invention.

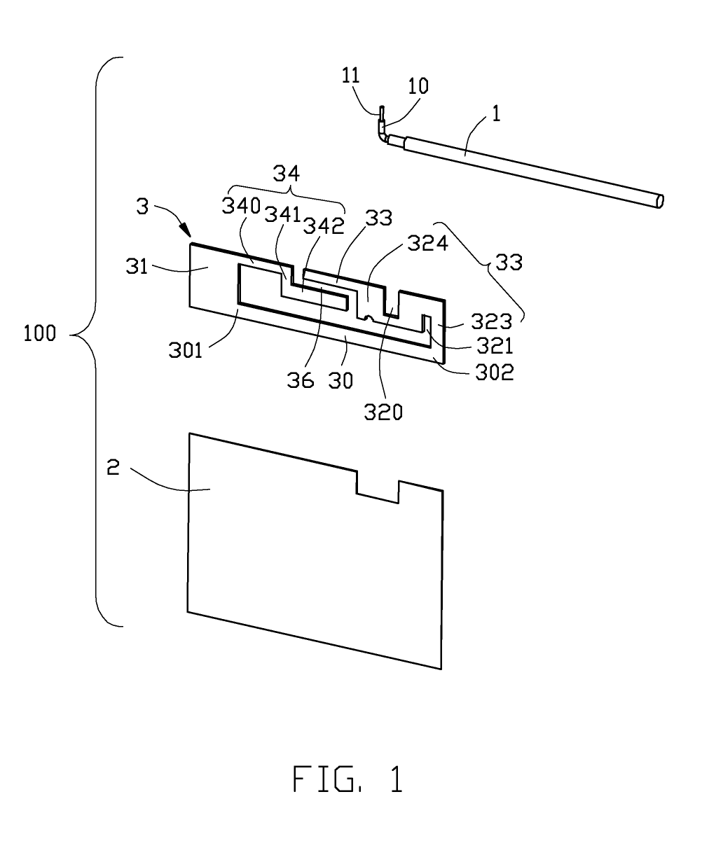

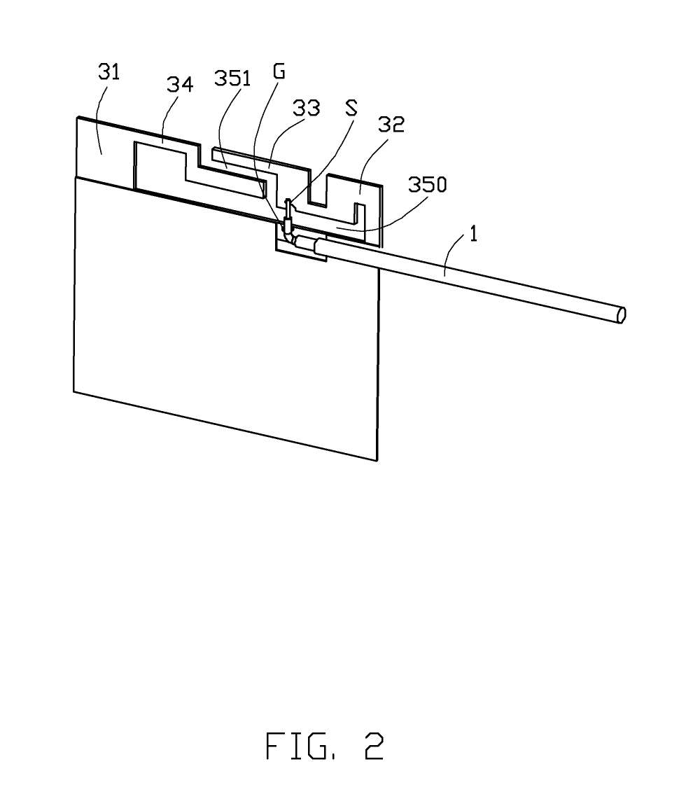

Referring to FIGS. 1 to 2, a multi-band antenna 100 according to the preferred embodiment of the present invention for assembling to an electronic device (not figured) is a planar inverted-F antenna. The antenna comprises a feeder cable 1, a metal foil 2 and an antenna body 3. The antenna body 3 is made from a metal plate and located in a plane of the metal plate, which includes a longitudinal ground portion 30 in a first direction and a first and second connecting portions 31, 32 respectively extending two opposite longitudinal ends 301, 302 of the grounding portion 30. A first (radiation) arm 34 substantially horizontally extends from the first connecting portion 31 and a second (radiation) arm 33 substantially horizontally extends from the second connecting portion 32 along the first direction. The first and second arms 34, 33 extending towards each other and partly overlap with each other in a second direction perpendicular to the first direction. The first and the second arms separate from the grounding portion 30 with a longitudinal first slot.

The first connecting portion 31 extends from an inner edge of the first end 301 of the grounding portion 30 in the second direction. The second connecting portion 32 extends from an inner edge of the second end 302 of the grounding portion 30 in the second direction and then bends in the first direction, therefore the second connecting portion 32 includes a first section 323 and a second section 324. A width of the horizontal section 324 in the second direction is larger than that of the grounding portion 30 in the second direction and that of the first section 323 in the first direction. The second section 324 defines an upward opening notch 320 therein. A downward opening slot 321 is defines between the first section 323 and the second section 324 in the first direction.

The first arm 34 of a zigzag shape includes a first arm section 340, a second arm section 342 extending in the first direction and a middle arm section 341 extending in the second direction to join with the first and the second arm sections together. The second arm section 342 is nearer to the grounding portion 35. The second arm 33 extends from the second section 324 and is located above the second arm section 342 in the second direction. A second slot 36 is defined between the second arm 33 and the second arm section 342

The feeder cable 1 includes an inner wire 11 soldered to a joint point S defined on a lower corner of the second section 324 near to the first arm and the grounding portion and an outer braider 10 soldered to a joint point G defined on the grounding portion 30. A main matching slot 350 is defined between the two joint points along the connecting portion and the grounding portion. The second arm section is coupled with the first arm and defines a coupling matching slot 351 between the second arm 33 and the second arm section 342. Therefore, the second arm 33 is functioned as a first radiating arm working in 5.15˜5.85 GHz frequency band and the first arm 34 is functioned as a second radiating arm working in 2.4˜2.5 GHz frequency band.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-band antenna comprising:
a feeder cable comprising an inner wire and an outer braider;
an antenna body comprising a longitudinal grounding portion along a first direction, a first connecting portion and a second connecting portion extending from opposite first and second ends of the grounding portion, a first arm extending from the first connecting portion and a second arm extending from the second connecting portion along the first direction;
the second connecting portion defining a joint point at a corner near to the first arm and the grounding portion, the inner wire of the feeder cable being soldered to the joint point and the outer braider of the feeder cable being soldered to the grounding portion;
wherein the first arm and the second arm are partly overlapped in a second direction perpendicular to the first direction.

2. The multi-band antenna as claimed in claim 1, wherein the multi-band antenna further comprises a grounding foil connecting to the grounding portion.

3. The multi-band antenna as claimed in claim 1, wherein the first arm comprises a first arm section extending from the first connecting portion in the first direction, a second arm section extending in the first direction and a middle arm portion extending in the second direction to connecting the first arm section and the second arm section together, the second arm section is located between the second arm and the grounding portion in the second direction.

4. The multi-band antenna as claimed in claim 3, wherein the second connecting portion comprises a first section extending from the second end of the grounding portion in the second direction and a second section extending from the first section in the first direction, said second arm extends from the second section.

5. The multi-band antenna as claimed in claim 4, wherein a width of the second section of the connecting portion in the second direction is larger than a width of the first section of the connecting portion is the first direction.

6. The multi-band antenna as claimed in claim 4, wherein the joint point is disposed at the second section of the second connecting portion, a downward opening slot is defined between the second section and the first section of the connecting portion.

7. The multi-band antenna as claimed in claim 4, wherein the second section of the second connecting portion defines an upward opening thereon.

8. The multi-band antenna as claimed in claim 1, wherein the antenna body is made from a metal plate and located in a plane of the metal plate.

9. A multi-band antenna comprising:
a feeder coil comprising an inner wire and an outer braider; and
an antenna body disposed a plane extending in a first direction and second direction, the antenna body defining a signal feeder point and a grounding feeder point;
the inner wire being soldered with the signal feeder point and the outer braider being soldered with the grounding feeder point, thereby defining a first antenna match slot;
wherein the antenna body further defines a first radiating arm working in a higher frequency band and extending from the signal feeder point and a second radiating arm which is coupling to the higher frequency radio arm and working in a lower frequency band, thereby defining a second antenna match slot between the first radiating radio arm and the second radiating arm.

10. The multi-band antenna as claimed in claim 9, wherein the antenna body defines a grounding portion extending in the first direction, said first and second radiating arm extending substantially in the first directing and the overlap from each other in the second direction.

11. A multi-band antenna comprising:
a grounding portion extending along a longitudinal direction with opposite first and second ends;
a first connection portion extending upwardly from the first end;
a second connection portion extending upwardly from the second end;
a Z-shaped first radiating arm extending from the first connection portion toward the second end;
an L-shaped second radiating arm extending from the second connection portion toward the first end; wherein
the first radiating arm and the second radiating arm are overlapped with each other in at least one of said longitudinal direction and a vertical direction which is perpendicular to said longitudinal direction while with a gap therebetween.

12. The multiband antenna as claimed in claim 11, further including a feeder cable with an inner conductor connected to a joint between the second radiating arm and the second connection portion.

13. The multiband antenna as claimed in claim 12, wherein said first radiating arm and said second radiating arm are overlapped with each other in both said longitudinal direction and said vertical direction, and said gap extends in a Z-shaped configuration.

14. The multiband antenna as claimed in claim 13, wherein a U-shaped slot is formed between a combination of said first radiating arm, the first connection, the second radiating arm, the second connection arm and the grounding portion, and in a plane defined by said longitudinal direction and said vertical direction, said U-shaped slot communicates with an exterior only via said Z-shaped gap.

15. The multiband antenna as claimed in claim 11, wherein said second connection portion extends with a path to be a combination of a vertical type L-shaped section connected to the second end, and a horizontal type L-shaped section connected to said vertical type L-shaped section.

16. The multiband antenna as claimed in claim 11, wherein an upward opening notch is located between the second radiating arm and the second connection portion in the longitudinal direction.

17. The multiband antenna as claimed in claim 11, wherein a metallic foil is attached to the grounding portion, and said metallic foil defines a cutout in which an outer conductor of the feeder cable is soldered to the grounding portion thereunder.

18. The multiband antenna as claimed in claim 11, wherein said first connection portion defines a first width and the second connection portion defines a second width smaller than the first width.

19. The multiband antenna as claimed in claim 11, wherein said first connection portion defines a first width and the first radiating arm defines a second width smaller than the first width.
